(19) United States
(12) Patent Application Publication
(10) Pub. No.: US 2011/0242665 A1
(43) Pub. Date: Oct. 6, 2011

(54) IMAGING APPARATUS

(75) Inventor: Masato Osawa, Tokyo (JP)

(73) Assignee: OLYMPUS CORPORATION, Tokyo (JP)

(21) Appl. No.: 13/075,942

(22) Filed: Mar. 30, 2011

(30) Foreign Application Priority Data
Mar. 31, 2010 (JP) 2010-080446

(51) Int. Cl. G02B 27/12

(52) U.S. Cl. 359/626

(57) ABSTRACT

A front curtain is biased by a biasing force so as to move from a third position on an optical path of an optical system to a fourth position at which the front curtain does not block a subject image being imaged by the optical system in a direction parallel to an imaging surface of an imaging element IMG. A rear curtain is biased by a biasing force so as to move from the third position on the optical path of the optical system to the fourth position at which the rear curtain does not block the subject image being imaged by the optical system in a direction parallel to the imaging surface of the imaging element IMG. A multiocular lens is moved by one or both of a front curtain driving mechanism and a rear curtain driving mechanism between a first position on the optical path of the optical system and a second position at which the multiocular lens does not block the subject image being imaged by the optical system in a direction parallel to the imaging surface of the imaging element IMG.

### BACKGROUND OF THE INVENTION

1. Field of the Invention

The present invention relates to an imaging apparatus which uses a multiocular lens such as a lenticular lens. Priority is claimed on Japanese Patent Application No. 2010-0804476, filed Mar. 31, 2010, the content of which is incorporated herein by reference.

2. Description of Related Art

In recent years, a method called a TTL phase-difference method has been generally used as a method for detecting the focal position of an imaging apparatus such as a single-lens reflex camera. However, in the TTL phase-difference method, since it is necessary to provide a dedicated focal position detection device in order to detect the focal position, the manufacturing costs of the apparatus increase. Moreover, since space must be provided in the imaging apparatus for the focal position detection device, the size of the imaging apparatus is increased.

In this regard, Japanese Publication Application No. 2009-169025 discloses an imaging apparatus which uses a movable multiocular lens. In this imaging apparatus, as shown in FIG. 7A, during a focusing operation, a multiocular lens 71 is disposed at the front side of an imaging element 72, and a subject image being imaged by the multiocular lens 71 is incident on the imaging element 72. At this time, a focal position is detected from the image output of the imaging element 72. Moreover, during photographing, as shown in FIG. 7B, the multiocular lens 71 rotates upward about a rotation shaft 73 to be moved to a position such that it does not block the subject image incident on the imaging element 72. In the imaging apparatus disclosed in Japanese Publication Application No. 2009-169025, since the focal position can be detected from the image output of the imaging element during the focusing operation, it is not necessary to provide a dedicated focal position detection device.

However, in the imaging apparatus disclosed in Japanese Publication Application No. 2009-169025, since it is necessary to provide a space for allowing the multiocular lens to rotate, the size of the imaging apparatus increases. On the other hand, Japanese Publication Application No. 2008-312080 discloses an imaging apparatus in which a multiocular lens slides in parallel along an imaging surface of an imaging element, thus reducing the size of the imaging apparatus as compared to that disclosed in Japanese Publication Application No. 2009-169025, for example.

### SUMMARY OF THE INVENTION

The invention provides an imaging apparatus including: an imaging element; an optical system that images light incident from a subject onto the imaging element; an autofocus mechanism which has a multiocular lens that moves between a first position on an optical path of the optical system and a second position at which the multiocular lens does not block a subject image being imaged by the optical system in a direction parallel to an imaging surface of the imaging element, and which regulates an imaging position of the optical system based on the output of the imaging element when the multiocular lens is positioned at the first position; a front curtain shutter which is biased by a biasing force so as to move from a third position on the optical path of the optical system to a fourth position at which the front curtain shutter does not block the subject image being imaged by the optical system in a direction parallel to the imaging surface of the imaging element; a rear curtain shutter which is biased by a biasing force so as to move from a fifth position at which the rear curtain shutter does not block the subject image being imaged by the optical system to a sixth position on the optical path of the optical system in a direction parallel to the imaging surface of the imaging element; a front curtain driving mechanism that moves the front curtain shutter from the fourth position to the third position; a front curtain holding mechanism that holds the front curtain shutter at the third position at which the biasing force is stored; a rear curtain driving mechanism that moves the rear curtain shutter from the sixth position to the fifth position; and a rear curtain holding mechanism that holds the rear curtain shutter at the fifth position at which the biasing force is stored, wherein the multiocular lens moves between the first position and the second position by one or both of the front curtain driving mechanism and the rear curtain driving mechanism.

Moreover, in the imaging apparatus of the invention, it is preferable that the multiocular lens is biased so as to move from the second position to the first position and is moved by the front curtain driving mechanism from the first position to the second position at which the biasing force is stored.

Moreover, in the imaging apparatus of the invention, it is preferable that the multiocular lens is biased so as to move from the first position to the second position, and is moved by the rear curtain driving mechanism from the second position to the first position at which the biasing force is stored as well as being held by the front curtain holding mechanism at the first position at which the biasing force is stored.

Moreover, in the imaging apparatus of the invention, it is preferable that the multiocular lens is moved by the front curtain driving mechanism from the first position to the second position and is moved by the rear curtain driving mechanism from the second position to the first position.

### BRIEF DESCRIPTION OF THE DRAWINGS

FIG. 1 is a block diagram showing a configuration of an imaging apparatus used in the embodiments of the invention.

FIG. 2 is a block diagram showing a configuration of a shutter section according to a first embodiment of the invention.

FIG. 3 is a reference diagram illustrating the positions of a multiocular lens, a front curtain, and a rear curtain in the first embodiment of the invention.

FIG. 4 is a block diagram showing a configuration of a shutter section according to a second embodiment of the invention.

FIG. 5 is a block diagram showing a configuration of a shutter section according to a third embodiment of the invention.

FIG. 6A is a reference diagram showing an operation of the imaging apparatus in the respective embodiments of the invention.

FIG. 6B is a reference diagram showing an operation of the imaging apparatus in the respective embodiments of the invention.

FIG. 6C is a reference diagram showing an operation of the imaging apparatus in the respective embodiments of the invention.

FIG. 6D is a reference diagram showing an operation of the imaging apparatus in the respective embodiments of the invention.

FIG. 7A is a reference diagram showing a method of driving a multiocular lens in an imaging apparatus that uses a movable multiocular lens.

FIG. 7B is a reference diagram showing a method of driving a multiocular lens in an imaging apparatus that uses a movable multiocular lens.

### DETAILED DESCRIPTION OF THE INVENTION

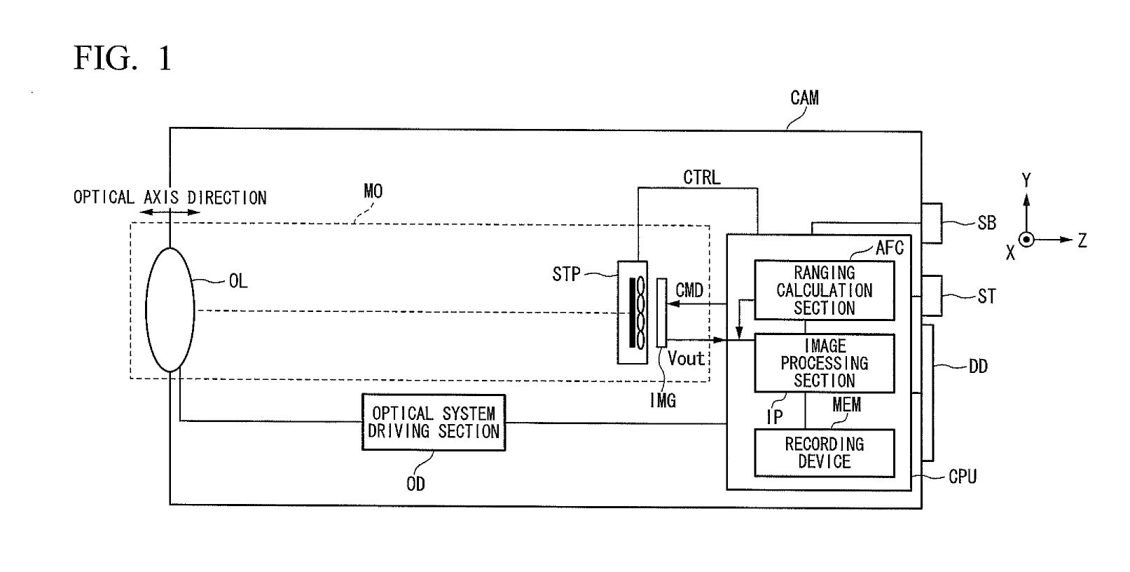

Hereinafter, the embodiments of the present invention will be described with reference to the drawings. FIG. 1 shows a configuration of an imaging apparatus used in the embodiments described later. An imaging apparatus CAM shown in FIG. 1 includes an imaging optical system MO, a signal processing section CPU, an optical system driving section OD, a setting button SB, a shutter button ST, and a display device DD.

The imaging optical system MO images a subject image and photographs the imaged subject image. The imaging optical system MO includes a replaceable photographic lens OL, an imaging element IMG, and a shutter section STP. The photographic lens OL is an optical system for imaging luminous fluxes of a subject onto the imaging element IMG. The photographic lens OL is driven by the optical system driving section OD so as to be freely movable in an optical axis direction. As the photographic lens OL moves in the optical axis direction, the focal position of the photographic lens OL moves. The imaging element IMG photoelectrically converts the incident subject image to output an image output Vout. The shutter section STP includes a shutter which has a front curtain and a rear curtain and a multiocular lens. A detailed configuration of the shutter section STP will be described later.

The signal processing section CPU includes a ranging calculation section AFC, an image processing section IP, and a recording device MEM. The signal processing section CPU is connected to the setting button SB, the shutter button ST, the display device DD, the imaging element IMG, the shutter section STP, and the optical system driving section OD. The signal processing section CPU performs control of the imaging apparatus CAM, signal processing, and the like based on signals input from the setting button SB and the shutter button ST and the image output Vout obtained from the imaging element IMG. Moreover, the signal processing section CPU outputs a control signal CTRL for the shutter section STP, a control signal for the optical system driving section OD, and a command CMD for the imaging element IMG. Furthermore, the signal processing section CPU outputs an image signal obtained through signal processing to the display device DD. Among the signal processing, processing corresponding to ranging calculation is performed by the ranging calculation section AFC, and processing such as display image processing is performed by the image processing section IP. Image signals subjected to signal processing are stored in the recording device MEM as necessary.

The optical system driving section OD moves the photographic lens OL so as to be freely movable in the optical axis direction. Specifically, the optical system driving section OD controls a lens driving motor (not shown) based on the results of calculations by the signal processing section CPU so as to move the photographic lens OL in the optical axis direction in order to achieve the in-focus state of the photographic lens OL. In this way, the imaging position of the photographic lens OL is regulated. The multiocular lens, the signal processing section CPU, and the optical system driving section OD constitute an autofocus mechanism.

The shutter button ST is a button used when a photographer determines a photographing timing. The setting button SB is a button used when a photographer determines an operation mode of the imaging apparatus CAM. The display device DD displays an image based on an image signal processed by the signal processing section CPU.

### First Embodiment

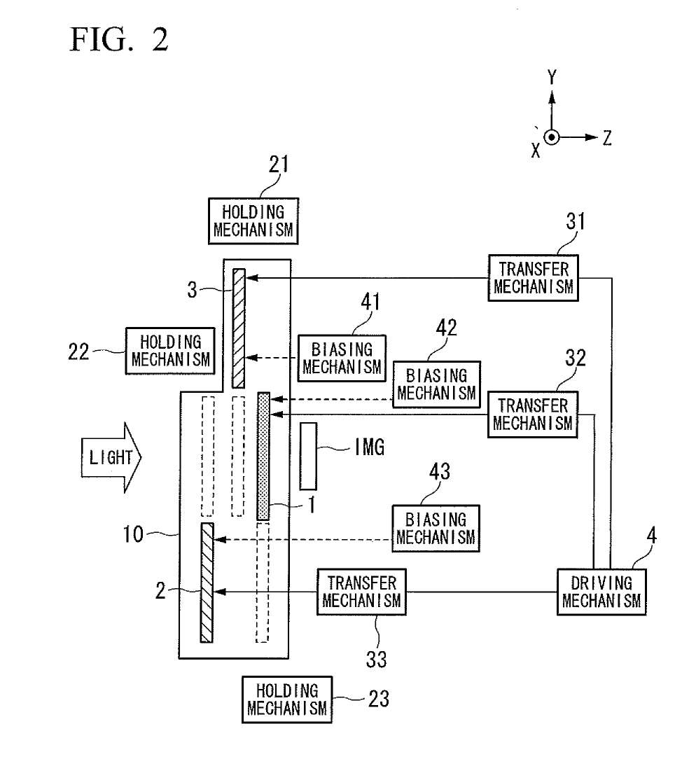

FIG. 2 shows a configuration of the shutter section SIP according to the first embodiment. The shutter section STP includes a multiocular lens 1, a front curtain 2, a rear curtain 3, a driving mechanism 4, a fixed frame 10, holding mechanisms 21, 22, and 23, transfer mechanisms 31, 32, and 33, and biasing mechanisms 41, 42, and 43.

The multiocular lens 1, the front curtain 2, and the rear curtain 3 are disposed within the fixed frame 10. The multiocular lens 1 is a lenticular lens which is an aggregation of a plurality of lenses, a fly-eye lens, or the like. The front curtain 2 and the rear curtain 3 are two curtains that constitute a focal plane shutter. The multiocular lens 1, the front curtain 2, and the rear curtain 3 are configured to be movable in a direction (the Y direction of FIG. 2 and the opposite direction thereof) parallel to the imaging surface of the imaging element IMG.

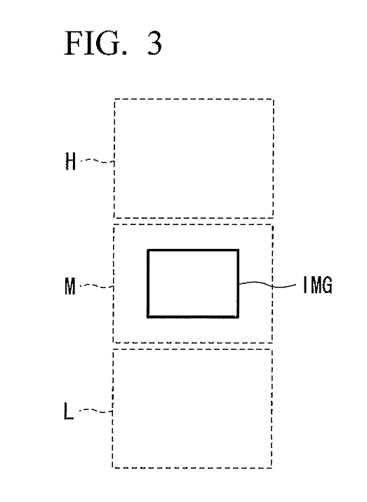

FIG. 3 shows the position at which the multiocular lens 1, the front curtain 2, and the rear curtain 3 stop. FIG. 3 is a drawing when the imaging apparatus CAM is seen in the Z direction of FIG. 2 from the front surface of the imaging apparatus CAM. FIG. 3 also shows the position of the imaging element IMG. The position at which the multiocular lens 1, the front curtain 2, and the rear curtain 3 stop is one of three different positions H, M, and L in the vertical direction. The position M is on the optical path of the photographic lens OL. The multiocular lens 1 can move between the positions M and L. The front curtain 2 can move between the positions M and L. The rear curtain 3 can move between the positions H and M.

The multiocular lens 1, the front curtain 2, and the rear curtain 3 receive a biasing force at one of the two positions at which they can stop and are moved to the other position by the biasing force. The driving mechanism generates a driving force for moving the multiocular lens 1, the front curtain 2, and the rear curtain 3 from a position at which the biasing force is released to a position at which the biasing force is stored.

In the first embodiment, the multiocular lens 1 receives the biasing force at the position L and is moved to the position M by the biasing force. Moreover, the multiocular lens 1 is moved from the position M to the position L by the driving force generated by the driving mechanism 4. The front curtain 2 receives the biasing force at the position M and is moved to the position L by the biasing force. Moreover, the front curtain 2 is moved from the position L to the position M by the driving force generated by the driving mechanism 4. The rear curtain receives the biasing force at the position H and is moved to the position M by the biasing force. Moreover, the rear curtain 3 is moved from the position M to the position H by the driving force generated by the driving mechanism 4.

The holding mechanisms 21, 22, and 23 are formed, for example, of an electromagnet or a permanent magnet and hold the multiocular lens 1, the front curtain 2, and the rear curtain 3 at the position at which the biasing force is stored. The holding mechanism 21 holds the rear curtain 3 at the position H at which the biasing force is stored. The holding mechanism 22 holds the front curtain 2 at the position M at which the biasing force is stored. The holding mechanism 23 holds the multiocular lens 1 at the position L at which the biasing force is stored. In this way, the holding mechanisms 21, 22, and 23 are mechanisms that hold the members while resisting the biasing force applied to the members by the biasing mechanisms. Mechanisms that hold the members while resisting a force other than the biasing force (for example, a gravitational force) are not illustrated.

The transfer mechanisms 31, 32, and 33 are formed, for example, of a toothed wheel (gear) and transfer the driving force generated by the driving mechanism 4 to the multiocular lens 1, the front curtain 2, and the rear curtain 3. The transfer mechanism 31 transfers the driving force to the rear curtain 3. The transfer mechanism 32 transfers the driving force to the multiocular lens 1. The transfer mechanism 33 transfers the driving force to the front curtain 2.

The biasing mechanisms 41, 42, and 43 are formed, for example, of a spring and apply the biasing force to the multiocular lens 1, the front curtain 2, and the rear curtain 3. The biasing mechanism 41 applies the biasing force to the rear curtain 3 held at the position H. The biasing mechanism 42 applies the biasing force to the multiocular lens 1 held at the position L. The biasing mechanism 43 holds the biasing force to the front curtain 2 held at the position M.

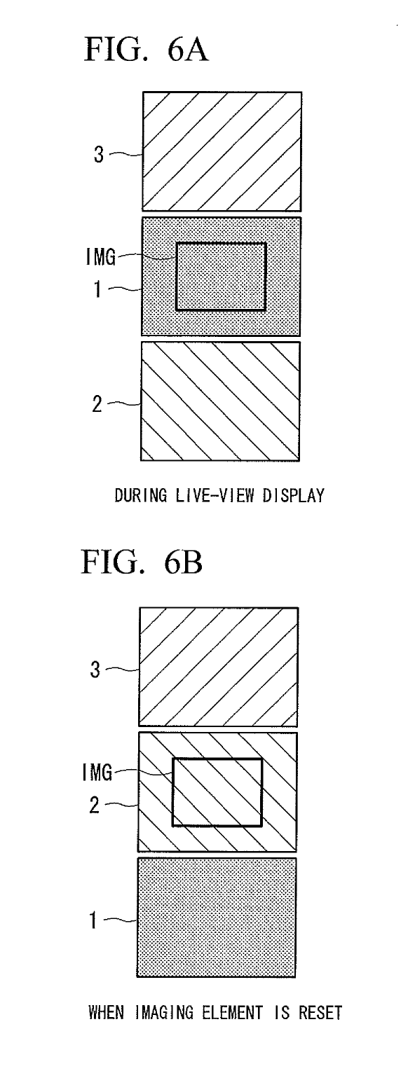

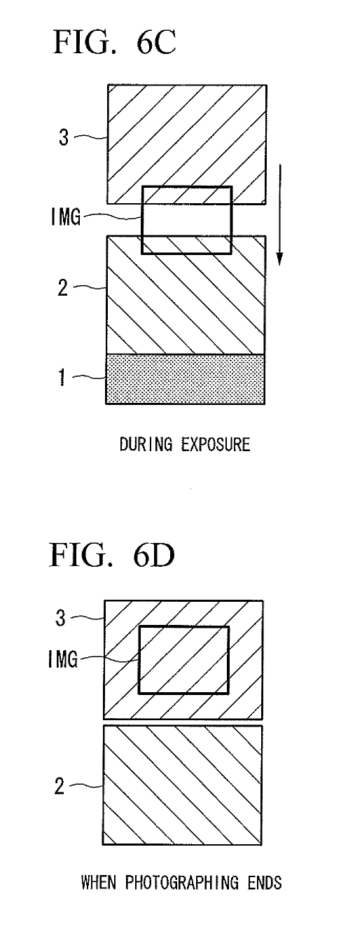

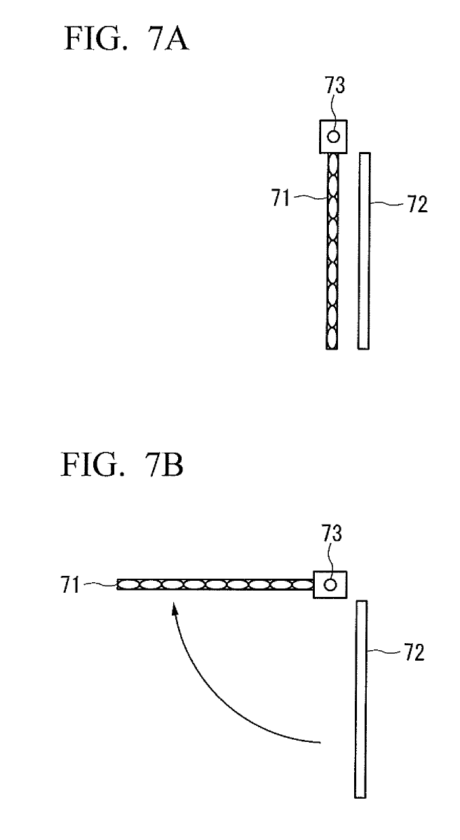

Next, the operation of the imaging apparatus CAM according to the present embodiment will be described. When power is input, the imaging apparatus CAM performs a live-view display operation of displaying in real-time an image that is photographed continuously. At that time, as shown in FIG. 6A, the multiocular lens 1 is positioned at the position M, and the front curtain 2 is positioned at the position L. The rear curtain 3 is held at the position H by the holding mechanism 21, at which the biasing force of the biasing mechanism 41 is stored.

In the live-view display operation, an image based on the image signal processed by the signal processing section CPU is displayed on the display device DD. Since the subject image having passed through the multiocular lens 1 is imaged on the imaging element IMG, the obtained image is sufficient for the photographer to check the angle of view or the like although the image is not a high-precision image. Moreover, during the live-view display operation, when the photographer half-presses the shutter button ST, an autofocus operation is executed. More specifically, the ranging calculation section AFC of the signal processing section CPU calculates a distance from the photographic lens OL to the subject based on the image output Vout from the imaging element IMG. The optical system driving section OD moves the photographic lens OL in the optical axis direction based on the calculation results of the ranging calculation section AFC.

Subsequently, when the shutter button ST is fully pressed, the imaging apparatus CAM performs a reset operation of resetting the imaging element IMG. At that time, as shown in FIG. 6B, the multiocular lens 1 is moved to the position L by the driving force generated by the driving mechanism 4, at which the biasing force of the biasing mechanism 42 is stored, and is held by the holding mechanism 23. The front curtain 2 is moved to the position M by the driving force generated by the driving mechanism 4, at which the biasing force of the biasing mechanism 43 is stored, and is held by the holding mechanism 22. The rear curtain 3 is moved to the position H at which the biasing force of the biasing mechanism 41 is stored, and remains held by the holding mechanism 21.

When the reset operation of the imaging element IMG ends, the imaging apparatus CAM performs an exposure operation. At that time, as shown in FIG. 6C, the front curtain 2 begins to be moved by the biasing force of the biasing mechanism 43, and after a small delay, the rear curtain 3 begins to be moved by the biasing force of the biasing mechanism 41. When the exposure operation ends and the photographing ends, as shown in FIG. 6D, the front curtain 2 is positioned at the position L, and the rear curtain 3 is positioned at the position M. The multiocular lens 1 remains held by the holding mechanism 23 at the position at which the biasing force of the biasing mechanism 42 is stored. Moreover, the image signals processed by the image processing section IP are stored in the recording device MEM.

When the photographing ends, the imaging apparatus CAM performs the live-view display operation again. The multiocular lens 1 is moved to the position M by the biasing force of the biasing mechanism 42. Moreover, the rear curtain 3 is moved to the position H by the driving force generated by the driving mechanism 4, at which the biasing force of the biasing mechanism 41 is stored, and is held by the holding mechanism 21.

As described above, according to the present embodiment, when the state shown in FIG. 6A transitions to the state shown in FIG. 6B, by the driving force generated by the driving mechanism 4, the multiocular lens 1 is moved to the position L and the front curtain 2 is moved to the position M. In this way, by performing the driving of the multiocular lens 1 and the driving of the front curtain 2 at the same time, the driving force generated by the driving mechanism 4 can be used for both the driving of the multiocular lens and the front curtain 2. Therefore, since a driving mechanism dedicated for the multiocular lens is not necessary, it is possible to reduce the size of the apparatus.

In the present embodiment, although an example in which the multiocular lens 1 moves between the position L at which the biasing force is stored and the position M at which the biasing force is released has been illustrated, the multiocular lens may move between the position H at which the biasing force is stored and the position M at which the biasing force is released. In this case, as a mechanism corresponding to the holding mechanism 23, a mechanism for holding the multiocular lens 1 at the position H may be provided separately from the mechanism for holding the rear curtain 3 at the position H.

### Second Embodiment

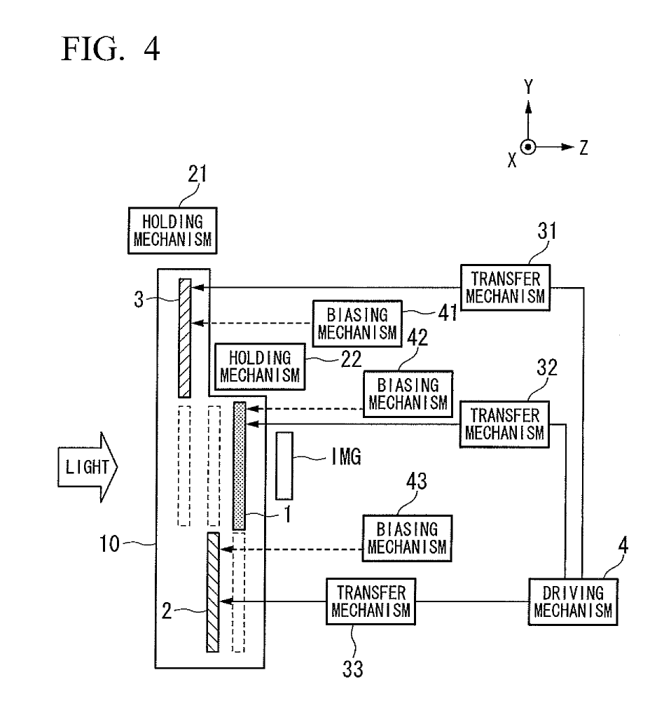

FIG. 4 shows the configuration of the shutter section STP according to the second embodiment. In FIG. 4, the same components as those of FIG. 2 are denoted by the same reference numerals. The holding mechanism 23 is omitted in FIG. 4 as compared to FIG. 2. In the present embodiment, the multiocular lens 1 receives the biasing force at the position M and is moved to the position L by the biasing force. Moreover, the multiocular lens 1 is moved from the position L to the position M by the driving force generated by the driving mechanism 4.

Hereinafter, the operation of the imaging apparatus CAM according to the present embodiment will be described. In the following description, only the operation regarding the movement of the multiocular lens 1, the front curtain 2, and the rear curtain 3 will be described. During the live-view display operation, as shown in FIG. 6A, the multiocular lens 1 is held at the position M by the holding mechanism 22, at which the biasing force of the biasing mechanism 42 is stored. The front curtain 2 is positioned at the position L. The rear curtain 3 is held at the position H by the holding mechanism 21, at which the biasing force of the biasing mechanism 41 is stored.

During the reset operation of the imaging element IMG, as shown in FIG. 6B, the multiocular lens 1 is moved to the position L by the biasing force of the biasing mechanism 42. The front curtain 2 is moved to the position M by the driving force generated by the driving mechanism 4, at which the biasing force of the biasing mechanism 43 is stored, and is held by the holding mechanism 22. The rear curtain 3 remains held by the holding mechanism 21 at the position H at which the biasing force of the biasing mechanism 41 is stored.

During the exposure operation, as shown in FIG. 6C, the front curtain 2 starts being moved by the biasing force of the biasing mechanism 43, and after a small delay, the rear curtain 3 begins to be moved by the biasing force of the biasing mechanism 41. When the exposure operation ends and the photographing ends, as shown in FIG. 6D, the front curtain 2 is positioned at the position L, and the rear curtain 3 is positioned at the position M. The multiocular lens 1 is positioned at the position L.

When the photographing ends and the imaging apparatus CAM performs the live-view display operation again, the multiocular lens 1 is moved to the position M by the driving force generated by the driving mechanism 4, at which the biasing force of the biasing mechanism 42 is stored, and is held by the holding mechanism 22. Moreover, the rear curtain 3 is moved to the position H by the driving force generated by the driving mechanism 4, at which the biasing force of the biasing mechanism 41 is stored, and is held by the holding mechanism 21.

As described above, according to the present embodiment, when the state shown in FIG. 6D transitions to the state shown in FIG. 6A, by the driving force generated by the driving mechanism 4, the multiocular lens 1 is moved to the position M and the rear curtain 3 is moved to the position H. In this way, by performing the driving of the multiocular lens 1 and the driving of the rear curtain 3 at the same time, the driving force generated by the driving mechanism 4 can be used for both the driving of the multiocular lens 1 and the rear curtain 3. Therefore, since a driving mechanism dedicated for the multiocular lens is not necessary, it is possible to reduce the size of the apparatus. Moreover, in the present embodiment, since the multiocular lens 1 is held at the position M, the multiocular lens 1 can be held by the holding mechanism 22 that holds the front curtain 2 at the position M. Thus, the holding mechanism 23 of the first embodiment can be omitted.

In the present embodiment, although an example in which the multiocular lens 1 moves between the position M at which the biasing force is stored and the position L at which the biasing force is released has been illustrated, the multiocular lens 1 may move between the position M at which the biasing force is stored and the position H at which the biasing force is released.

### Third Embodiment

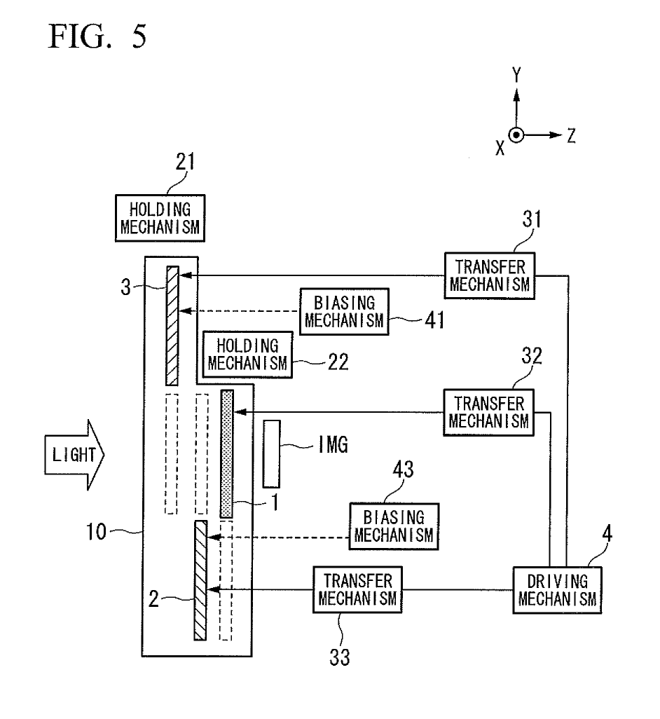

FIG. 5 shows the configuration of the shutter section STP according to the third embodiment. In FIG. 5, the same components as those of FIG. 2 are denoted by the same reference numerals. The holding mechanism 23 and the biasing mechanism 42 are omitted in FIG. 5 as compared to FIG. 2. In the present embodiment, the multiocular lens 1 does not use the biasing force applied by the biasing mechanism but is moved between the position L and the position M by the driving force generated by the driving mechanism 4.

Hereinafter, the operation of the imaging apparatus CAM according to the present embodiment will be described. In the following description, only the operation regarding the movement of the multiocular lens 1, the front curtain 2, and the rear curtain 3 will be described. During the live-view display operation, as shown in FIG. 6A, the multiocular lens 1 is positioned at the position M, and the front curtain 2 is positioned at the position L. The rear curtain 3 is held at the position H by the holding mechanism 21, at which the biasing force of the biasing mechanism 41 is stored.

During the reset operation of the imaging element IMG, as shown in FIG. 6B, the multiocular lens 1 is moved to the position M by the driving force generated by the driving mechanism 4. The front curtain 2 is moved to the position L by the driving force generated by the driving mechanism 4, at which the biasing force of the biasing mechanism 43 is stored, and is held by the holding mechanism 22. The rear curtain 3 remains held by the holding mechanism 21 at the position H at which the biasing force of the biasing mechanism 41 is stored.

During the exposure operation, as shown in FIG. 6C, the front curtain 2 begins to be moved by the biasing force of the biasing mechanism 43, and after a small delay, the rear curtain 3 begin to be moved by the biasing force of the biasing mechanism 41. When the exposure operation ends and the photographing ends, as shown in FIG. 6D, the front curtain 2 is positioned at the position L, and the rear curtain 3 is positioned at the position M. The multiocular lens 1 is positioned at the position L.

When the photographing ends and the imaging apparatus CAM perform the live-view display operation again, the multiocular lens 1 is moved to the position M by the driving force generated by the driving mechanism 4. Moreover, the rear curtain 3 is moved to the position H by the driving force generated by the driving mechanism 4, at which the biasing force of the biasing mechanism 41 is stored, and is held by the holding mechanism 21.

As described above, according to the present embodiment, when the state shown in FIG. 6A transitions to the state shown in FIG. 6B, by the driving force generated by the driving mechanism 4, the multiocular lens 1 is moved to the position L and the front curtain 2 is moved to the position M. Moreover, when the state shown in FIG. 6D transitions to the state shown in FIG. 6A, by the driving force generated by the driving mechanism 4, the multiocular lens 1 is moved to the position M and the rear curtain 3 is moved to the position H. In this way, by performing the driving of the multiocular lens 1 and the driving of the front curtain 2 or the rear curtain 3 at the same time, the driving force generated by the driving mechanism 4 can be used for both the driving of the multiocular lens 1 and the front curtain 2 or the rear curtain 3. Therefore, since a driving mechanism dedicated for the multiocular lens is not necessary, it is possible to reduce the size of the apparatus. Moreover, in the present embodiment, since the movement of the multiocular lens 1 does not require the biasing force, the biasing mechanism 42 and the holding mechanism 23 of the first embodiment can be omitted.

In the present embodiment, although an example in which the multiocular lens 1 moves between the position M and the position L has been illustrated, the multiocular lens 1 may move between the position M and the position H.

While the embodiments of the invention have been described in detail with reference to the drawings, a specific configuration is not limited to the embodiments. Additions, omissions, substitutions, and other modifications can be made in the configuration without departing from the spirit or scope of the invention. For example, although a case in which one driving mechanism is provided has been described, even when a front curtain driving mechanism and a rear curtain driving mechanism are provided separately, it is possible to move the multiocular lens using any one of the driving mechanisms when moving the multiocular lens.

According to the invention, by moving the multiocular lens using one or both of the front curtain driving mechanism and the rear curtain driving mechanism, it is possible to omit a driving mechanism dedicated for the multiocular lens. Thus, it is possible to reduce the size of the apparatus.

What is claimed is:

1. An imaging apparatus comprising:
an imaging element;
an optical system that images light incident from a subject onto the imaging element:
an autofocus mechanism which has a multiocular lens that moves between a first position on an optical path of the optical system and a second position at which the multiocular lens does not block a subject image being imaged by the optical system in a direction parallel to an imaging surface of the imaging element, and which regulates an imaging position of the optical system based on the output of the imaging element when the multiocular lens is positioned at the first position;
a front curtain shutter which is biased by a biasing force so as to move from a third position on the optical path of the optical system to a fourth position at which the front curtain shutter does not block the subject image being imaged by the optical system in a direction parallel to the imaging surface of the imaging element;
a rear curtain shutter which is biased by a biasing force so as to move from a fifth position at which the rear curtain shutter does not block the subject image being imaged by the optical system to a sixth position on the optical path of the optical system in a direction parallel to the imaging surface of the imaging element;
a front curtain driving mechanism that moves the front curtain shutter from the fourth position to the third position;
a front curtain holding mechanism that holds the front curtain shutter at the third position at which the biasing force is stored;
a rear curtain driving mechanism that moves the rear curtain shutter from the sixth position to the fifth position; and
a rear curtain holding mechanism that holds the rear curtain shutter at the fifth position at which the biasing force is stored,
wherein the multiocular lens moves between the first position and the second position by one or both of the front curtain driving mechanism and the rear curtain driving mechanism.

2. The imaging apparatus according to claim 1,
wherein the multiocular lens is biased so as to move from the second position to the first position and is moved by the front curtain driving mechanism from the first position to the second position at which the biasing force is stored.

3. The imaging apparatus according to claim 1,
wherein the multiocular lens is biased so as to move from the first position to the second position, and is moved by the rear curtain driving mechanism from the second position to the first position at which the biasing force is stored as well as being held by the front curtain holding mechanism at the first position at which the biasing force is stored.

4. The imaging apparatus according to claim 1,
wherein the multiocular lens is moved by the front curtain driving mechanism from the first position to the second position and is moved by the rear curtain driving mechanism from the second position to the first position.
